(19) United States
(12) Patent Application Publication
(10) Pub. No.: US 2021/0109372 A1
(43) Pub. Date: Apr. 15, 2021

(54) COMFORT FIT SLIP-RESISTANT EYEWEAR SYSTEM

(71) Applicant: LooLoops, LLC, Scottsdale, AZ (US)

(72) Inventors: Kent Chill Loo, Scottsdale, AZ (US); Joseph Pepe Elijio Velasquez, Tempe, AZ (US); Daniel W Allen, Mesa, AZ (US); Joseph M Barrett, Tempe, AZ (US)

(73) Assignee: LooLoops, LLC, Scottsdale, AZ (US)

(21) Appl. No.: 17/069,273

(22) Filed: Oct. 13, 2020

Related U.S. Application Data
(60) Provisional application No. 62/913,737, filed on Oct. 11, 2019.

(51) Int. Cl. G02C 5/12

(52) U.S. Cl. CPC G02C 5/124; G02C 2200/18

(57) ABSTRACT

An anti-slip eyewear system comprising a nosepiece configured to couple to a bridge of an eyewear frame, the nosepiece comprising a core comprised of a first material and an outer layer at least partially surrounding or overlapping the core and comprised of a second material, the second material having a lower durometer than the first material, wherein the second material creates a plurality of Schallamach waves on an outer surface of the nosepiece when the outer layer of the nosepiece is in contact with at least a portion of a face of a user. The first material may have a durometer greater than about Shore 40A on the Shore A hardness scale and the second material may have a durometer less than about Shore 40A on the Shore A hardness scale.

### CROSS REFERENCE TO RELATED APPLICATIONS

This application claims priority to U.S. Provisional Patent Application No. 62/913,737 filed on Oct. 11, 2019, entitled “Comfort Fit Slip-Resistant Eyewear System” to Loo, et al., the contents of which is hereby incorporated by reference in its entirety.

### BACKGROUND

### 1. Field of the Invention

Exemplary embodiments generally relate to an eyewear system design for enhanced user comfort and slip resistance.

### 2. Related Art

Eyewear is generally designed to fit a pre-determined face shape and anatomical structure, which causes many wearers to experience a poor fit, which is particularly the case for people who lack prominent facial and nasal bridge structures. Conventional eyewear typically relies on two hard nose pads that rest on either side of the nose to support the eyewear; however, many wearers find these hard nose pads to be uncomfortable and inadequate to hold the eyewear in a proper position without slipping, sliding, or leaving marks on the user's nasal bridge after removal.

### SUMMARY

Implementations of an anti-slip eyewear system may comprise a nosepiece configured to couple to a bridge of an eyewear frame, the nosepiece comprising a core comprised of a first material and an outer layer at least partially surrounding the core and comprised of a second material, the second material having a lower durometer than the first material. The second material creates a plurality of Schallamach waves on an outer surface of the nosepiece when the outer layer of the nosepiece is in contact with at least a portion of a face of a user.

Particular aspects may comprise one or more of the following features. The first material may have a durometer greater than about Shore 40A on the Shore A hardness scale. The second material may have a durometer less than about Shore 40A on the Shore A hardness scale. The nosepiece may further comprise an attachment tab configured to seat within a slot on a bridge of an eyewear frame. The nosepiece may further comprise a plurality of attachment arms configured to couple the nosepiece to a bridge of an eyewear frame. The nosepiece may further comprise an adhesive configured to couple the nosepiece to a bridge of an eyewear frame. The nosepiece may comprise a saddle shape configured to engage a nasion and a nose of a user. The saddle shape may be comprised of an upper nosepiece portion and a plurality of nose pads.

Implementations of an anti-slip eyewear system may comprise a nosepiece configured to couple to a bridge of an eyewear frame, the nosepiece comprising a core comprised of a first material and an outer layer at least partially overlapping the core and comprised of a second material, the second material having a lower durometer than the first material The second material creates a plurality of Schallamach waves on an outer surface of the nosepiece when the outer layer of the nosepiece is in contact with at least a portion of a face of a user.

Particular aspects may comprise one or more of the following features. The first material may have a durometer greater than about Shore 40A on the Shore A hardness scale. The second material may have a durometer less than about Shore 40A on the Shore A hardness scale. The nosepiece may comprise a saddle shape configured to engage a nasion and a nose of a user.

Implementations of a method for preventing slippage of an eyewear system may comprise coupling a nosepiece to a bridge of an eyewear frame, the nosepiece comprising a core comprised of a first material and an outer layer at least partially overlapping the core and comprised of a second material, the second material having a lower durometer than the first material. The method further comprises creating a plurality of Schallamach waves in the second material on the outer layer of the nosepiece when the outer layer of the nosepiece is in contact with at least a portion of a face of a user.

Particular aspects may comprise one or more of the following features. The first material may have a durometer greater than about Shore 40A on the Shore A hardness scale. The second material may have a durometer less than about Shore 40A on the Shore A hardness scale. The method may further comprise seating an attachment tab within a slot on a bridge of an eyewear frame. The method may further comprise coupling a plurality of attachment arms of the nosepiece to a bridge of an eyewear frame. The method may further comprise adhering the nosepiece to a bridge of an eyewear frame using an adhesive. The nosepiece may comprise a saddle shape configured to engage a nasion and a nose of a user. The saddle shape may be comprised of an upper nosepiece portion and a plurality of nose pads.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112(f). Thus, the use of the words “function,” “means” or “step” in the Detailed Description or Brief Description of the Drawings or claims is not intended to somehow indicate a desire to invoke the special provisions of 35 U.S.C. § 112(f), to define the invention. To the contrary, if the provisions of 35 U.S.C. § 112(f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112(f). Moreover, even if the provisions of 35 U.S.C. § 112(f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

The foregoing and other aspects, features, and advantages will be apparent to those artisans of ordinary skill in the art from the DETAILED DESCRIPTION and DRAWINGS, and from the CLAIMS.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein. Elements and acts in the figures are illustrated for simplicity and have not necessarily been rendered according to any particular sequence or embodiment.

FIGS. 1-3 depict an embodiment of a nosepiece comprising an attachment tab.

FIGS. 4-7 depict embodiments of a nosepiece comprising attachment arms.

FIGS. 8-17 depict various methods of attaching a nosepiece to an eyewear frame.

FIGS. 18-20 depict an implementation of a nosepiece comprising an adhesive.

FIGS. 21-24 depict various nosepiece shapes.

FIGS. 25-27 depict implementations of nosepieces to retrofit an existing eyewear frame.

FIGS. 28-34 and 97-104 depict implementations of a snap-in nosepiece.

FIGS. 35-40 depict implementations of a friction fit nosepiece.

FIGS. 41-56 depict implementations of a nosepiece comprising a higher durometer core.

FIGS. 57-59 depict an implementation of a hemispherical nosepiece comprising a plurality of layers.

FIGS. 60-67 depict implementations of a snap-in nosepiece.

FIGS. 68-70 depict implementations of a grooved nosepiece.

FIGS. 71-75 depict an implementation of an eyewear system comprising a nasion pad and two nose pads.

FIGS. 76-80 depict implementations of a tubular nosepiece.

FIGS. 81-83 depict a nosepiece comprising a flexible strip.

FIGS. 84-88 and 112-121 depict implementations of an adhesive nosepiece.

FIGS. 89-93 depict implementations of a cylindrical nosepiece.

FIGS. 94-96 depict an implementation of a nosepiece comprising an upper flap.

FIGS. 105-111 depict implementations of a saddle-style nosepiece.

FIGS. 122-123 depict an implementation of a nosepiece comprising a cutout covered by a sheet of low durometer material.

FIGS. 124-126 depict implementations of a nosepiece comprising an air pocket.

### DETAILED DESCRIPTION

This disclosure, its aspects and implementations, are not limited to the specific components or assembly procedures disclosed herein. Many additional components and assembly procedures known in the art consistent with the intended eyewear systems and/or assembly procedures for eyewear will become apparent for use with implementations of the eyewear systems of this disclosure. Accordingly, for example, although particular eyewear systems are disclosed, such eyewear systems and implementing components may comprise any shape, size, style, type, model, version, measurement, concentration, material, quantity, and/or the like as is known in the art for such eyewear systems and implementing components, consistent with the intended operation of eyewear.

Contemplated as part of this disclosure are various embodiments of comfort fit and slip resistant eyewear systems and their respective components. It is noted that although some figures provided herein depict retrofitting existing eyewear systems while other depict custom eyewear frames, the disclosures described herein may be applied to any of a variety of eyewear frames and eyewear systems.

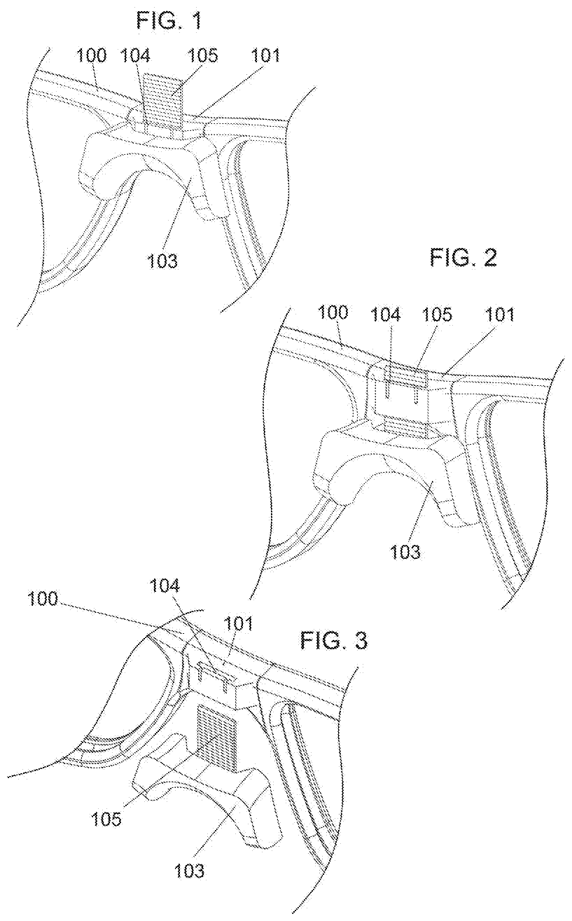

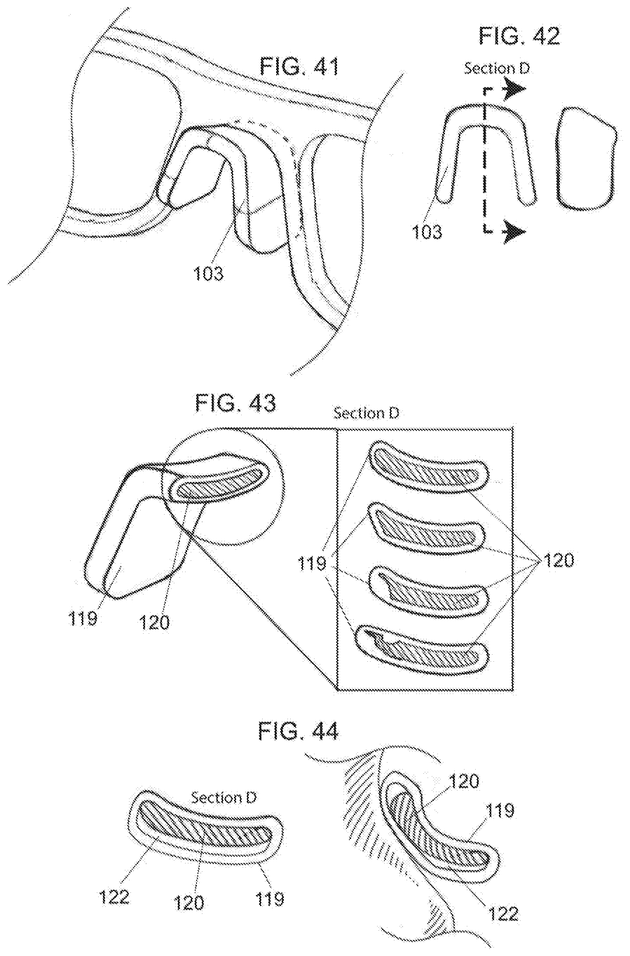

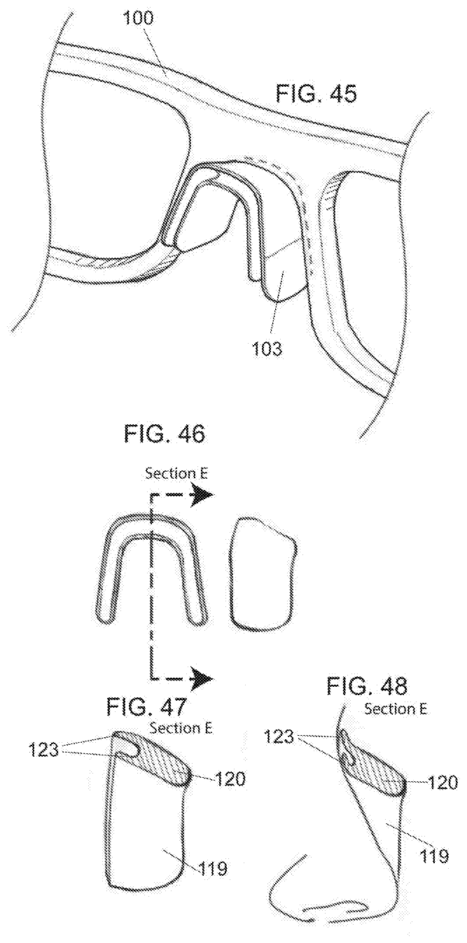

Because of the unique anatomical structure of each person's face, a need exists for a customizable and personalized comfortable eyewear fit. The inventions disclosed herein focus on providing enhanced eyewear comfort, fit, and performance. According to some aspects, as shown in FIGS. 1-59, a single nosepiece 103 that is configured to couple to the bridge 101 of an eyewear frame 100 and rest on the nasion of the wearer may be used to increase comfort and reduce slippage of the eyewear when in use. In some embodiments, the nosepiece 103 is comprised of an inner core 120 comprising one or more materials having a higher durometer relative to the outer layer 119 to provide structure and shape to the nosepiece 103. For the purposes of this disclosure, the term higher durometer material is intended to refer to materials within, but not limited to about the following durometer ranges within the Shore A Hardness Scale: greater than about Shore 40A; greater than about Shore 50A; greater than about Shore 60A; greater than about Shore 70A; greater than about Shore 80A; greater than about Shore 90A; about Shore 40A-about Shore 100A; about Shore 40A-about Shore 90A; about Shore 40A-about Shore 80A; about Shore 40A-about Shore 70A; about Shore 40A-about Shore 60A; about Shore 40A-about Shore 50A; about Shore 50A-about Shore 100A; about Shore 50A-about Shore 90A; about Shore 50A-about Shore 80A; about Shore 50A-about Shore 70A; about Shore 50A-about Shore 60A; about Shore 60A-about Shore 100A; about Shore 60A-about Shore 90A; about Shore 60A-about Shore 80A; about Shore 60A-about Shore 70A; about Shore 70A-about Shore 100A; about Shore 70A-about Shore 90A; about Shore 70A-about Shore 80A; about Shore 80A-about Shore 100A; about Shore 80A-about Shore 90A; about Shore 90A-about Shore 100A. An outer layer comprising a soft, low durometer material may surround at least a portion of the inner core of the nosepiece to enhance the grip of the nosepiece on the user's nasion and/or nasal bridge. For the purposes of this disclosure, the terms soft, low durometer material or low durometer material are intended to refer to materials within, but not limited to, about the following durometer ranges within the Shore A Hardness Scale: Less than about Shore 40A; Less than about Shore 35A; Less than about Shore 30A; Less than about Shore 25A; Less than about Shore 20A; Less than about Shore 15A; Less than about Shore 10A; Less than about Shore 5A; about Shore 0A-about Shore 40A; about Shore 0A-about Shore 35A; about Shore 0A-about Shore 30A; about Shore 0A-about Shore 25A; about Shore 0A-about Shore 20A; about Shore 0A-about Shore 15A; about Shore 0A-about Shore 10A; about Shore 0A-about Shore 5A; about Shore 5A-about Shore 40A; about Shore 5A-about Shore 35A; about Shore 5A-about Shore 30A; about Shore 5A-about Shore 25A; about Shore 5A-about Shore 20A; about Shore 5A-about Shore 15A; about Shore 5A-about Shore 10A; about Shore 10A-about Shore 40A; about Shore 10A-about Shore 35A; about Shore 10A-about Shore 30A; about Shore 10A-about Shore 25A; about Shore 10A-about Shore 20A; about Shore 10A-about Shore 15A; about Shore 15A-about Shore 40A; about Shore 15A-about Shore 35A; about Shore 10A-about Shore 30A; about Shore 15A-about Shore 25A; about Shore 15A-about Shore 20A; about Shore 20A-about Shore 40A; about Shore 20A-about Shore 35A; about Shore 20A-about Shore 30A; about Shore 20A-about Shore 25A; about Shore 25A-about Shore 40A; about Shore 25A-about Shore 35A; about Shore 25A-about Shore 30A; about Shore 30A-about Shore 40A; about Shore 30A-about Shore 35A; and about Shore 35A to about Shore 40A and/or the following durometer ranges within the Shore 00 Hardness Scale: less than about 80 Shore 00; less than about 70 Shore 00; less than about 60 Shore 00; less than about 50 Shore 00; less than about 40 Shore 00; less than about 30 Shore 00; less than about 20 Shore 00; less than about 10 Shore 00; about 0 Shore 00-about 80 Shore 00; about 0 Shore 00-about 70 Shore 00; about 0 Shore 00-about 60 Shore 00; about 0 Shore 00-about 50 Shore 00; about 0 Shore 00-about 40 Shore 00; about 0 Shore 00-about 30 Shore 00; about 0 Shore 00-about 20 Shore 00; about 0 Shore 00-about 10 Shore 00; about 10 Shore 00-about 80 Shore 00; about 10 Shore 00-about 70 Shore 00; about 10 Shore 00-about 60 Shore 00; about 10 Shore 00-about 50 Shore 00; about 10 Shore 00-about 40 Shore 00; about 10 Shore 00-about 30 Shore 00; about 10 Shore 00-about 20 Shore 00; about 20 Shore 00-about 80 Shore 00; about 20 Shore 00-about 70 Shore 00; about 20 Shore 00-about 60 Shore 00; about 20 Shore 00-about 50 Shore 00; about 20 Shore 00-about 40 Shore 00; about 20 Shore 00-about 30 Shore 00; about 30 Shore 00-about 80 Shore 00; about 30 Shore 00-about 70 Shore 00; about 30 Shore 00-about 60 Shore 00; about 30 Shore 00-about 50 Shore 00; about 30 Shore 00-about 40 Shore 00; about 40 Shore 00-about 80 Shore 00; about 40 Shore 00-about 70 Shore 00; about 40 Shore 00-about 60 Shore 00; about 40 Shore 00-about 50 Shore 00; about 50 Shore 00-about 80 Shore 00; about 50 Shore 00-about 70 Shore 00; about 50 Shore 00-about 60 Shore 00; about 60 Shore 00-about 80 Shore 00; about 60 Shore 00-about 70 Shore 00; and about 70 Shore 00-about 80 Shore 00. The low durometer outer layer 119 may be comprised of one or more thin sheets or flaps of low durometer material. When this low durometer material 119 is in contact with the user's nasion and/or nasal bridge, gravitational force is acting on the eyewear frame. The vector components of the gravitational force cause the nosepiece to drag slightly across the skin thereby creating tiny wrinkles known as Schallamach waves on the surface of the low durometer material 119. These tiny wrinkles reduce slippage of the eyewear down the nasal bridge due to the enhanced frictional forces that they provide. It is to be understood that any of the embodiments of nosepieces 103 or nose pads 117 described herein may be comprised of the aforementioned higher durometer inner core 120 and lower durometer outer layer 119.

FIGS. 1-3 depict an embodiment of an eyewear frame 100 comprising a slot 104 within a bridge 101 of the eyewear frame 100 that is configured to receive a corresponding attachment tab 105 of a nosepiece 103 that is configured to engage a user's nasion and nasal bridge. The attachment tab 105 may comprise one or more ridges, protrusions, or indentations configured to hold the nosepiece 103 at a plurality of various heights relative to the eyewear bridge 101. This allows a user to customize the placement of the nosepiece 103 to a desired height. Once the desired position is achieved, any excess length of the attachment tab 105 that extends above the slot 104 in the bridge 101 may be removed by cutting, breaking, or otherwise detaching the excess length.

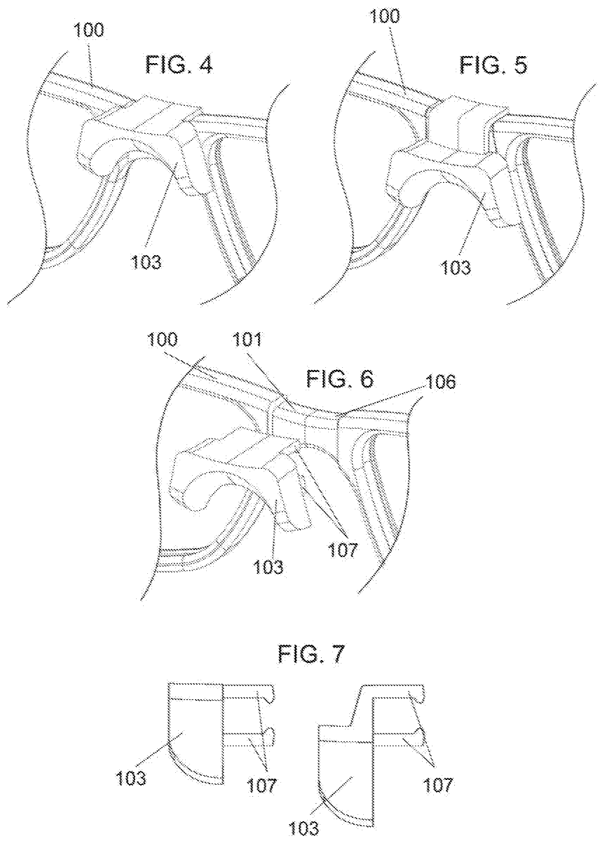

FIGS. 4-7 depict embodiments of an eyewear system comprising a notch 106 within the bridge 101 of the eyewear frame 100 that is configured to secure a nosepiece 103 to the eyewear frame 100 in a position that allows the nosepiece 103 to engage with the user's nasion and nasal bridge. As shown, the nosepiece 103 may comprise a plurality of attachment arms 107 or other clipping mechanism extending outward from the nosepiece 103 and configured to snap onto the notched bridge 101 of the eyewear frame 100. In some implementations, the attachment arms 107 may be stationary and/or integral to the nosepiece 103 and various nosepieces may be available having the attachment arms 107 positioned at different heights so that a user may select a nosepiece 103 having attachment arms 107 at a location that allows the nosepiece 103 to be located at an optimal height when attached to the eyewear frame 100. In other embodiments, the positioning of the attachment arms 107 may be adjustable so that the user may simply slide or otherwise move the attachment arms 107 to a position that allows the nosepiece 103 to be located at an optimal height.

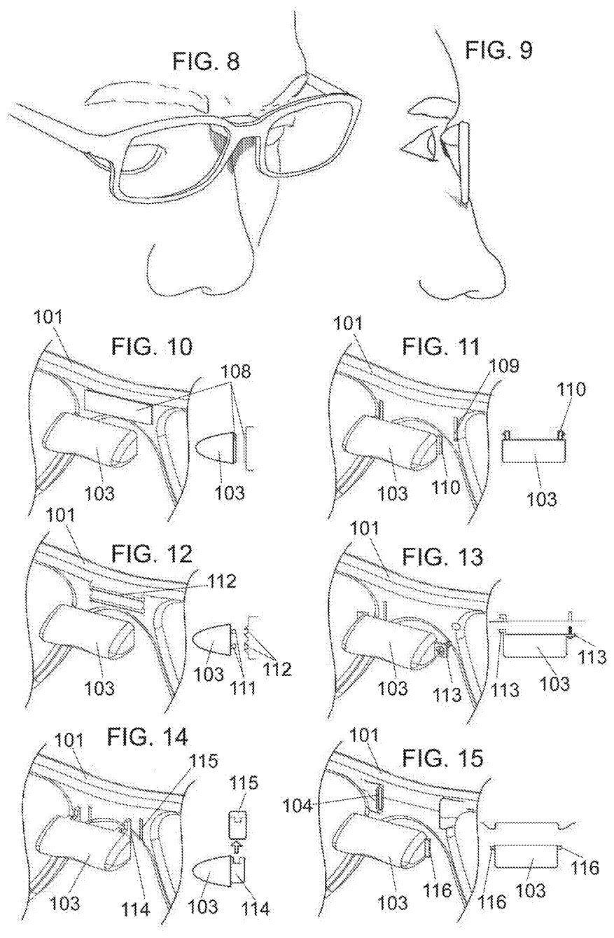

FIGS. 8-15 depict various configurations used to attach a nosepiece 103 to an eyewear frame 100. As shown in FIGS. 8-9, a nosepiece 103 configured to engage a user's nasion may be coupled to the eyewear frame 100 using a magnetic fit such that a magnetic element positioned in the nosepiece 103 is held in place by the magnetic attraction to the eyewear frame 100 or a magnetic element located in or on the bridge 101 of the eyewear frame 100. Alternatively, as shown in FIG. 10, the nosepiece 103 and bridge 101 of the eyewear frame may comprise corresponding snapping components 108 that allow the nosepiece 103 to be snapped into place on the bridge 101 of the eyewear frame 100. FIG. 11 depicts an embodiment in which the nosepiece 103 and the eyewear frame 100 comprise a corresponding sliding rail 109 and track 110 configured to allow the nosepiece to slide into place at the bridge 101 of the eyewear frame 100. FIG. 12 shows an implementation in which the nosepiece 103 and eyewear bridge 101 comprise one or more corresponding snapping tabs 111 and one or more recesses 112 configured to receive the one or more snapping tabs 111. FIG. 13 depicts a nosepiece 103 comprising one or more flanges 113 extending outwardly from one or more sides of the nosepiece 103, the one or more flanges 113 comprising an opening therethrough configured to receive a screw and mate with a corresponding opening in the eyewear frame 100. FIG. 14 depicts a nosepiece 103 comprising one or more slide elements 114 extending from the nosepiece 103 and configured to mate with one or more corresponding receiving elements 115 in or on the eyewear bridge 101 to secure the nosepiece 103 in place. FIG. 15 shows an implementation of a nosepiece 103 comprising one or more spring fit elements 116 extending outward from one or more sides of the nosepiece 103. To secure the nosepiece 103 in place, a user may pinch the sides of the nosepiece 103 to insert the one or more spring fit elements 116 into one or more corresponding slots 104 on the eyewear frame 100.

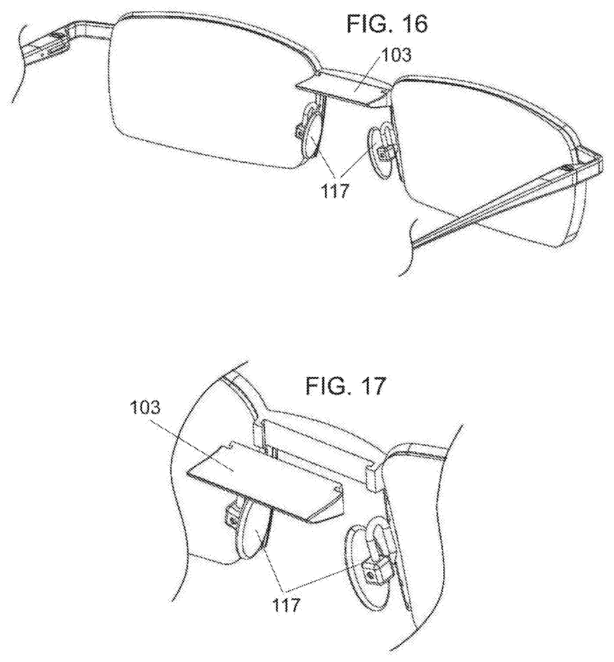

Some implementations of a comfort fit, slip resistant eyewear frame 100 may comprise a nosepiece 103 configured to couple to the bridge 101 of an eyewear frame 100 and engage the nasion of a user as well as two adjustable nose pads 117 configured to engage the user's nasal bridge. As shown in FIGS. 16-17, the nosepiece 103 may clip or otherwise snap into place on the bridge 101 of the eyewear frame 100. Each nose pad 117 may comprise an extension arm 118 comprising a first end configured to slide along a hollow rail of the eyewear frame 100 and lock into one of a plurality of positions along the hollow rail according to the user's desired positioning. It is intended that this implementation gives the user multiple options for customizing the fit of the eyewear by coupling only the nosepiece 103, only the nose pads 117, or both the nosepiece 103 and the nose pads 117 to the eyewear frame 100 depending on the desired amount of frictional resistance.

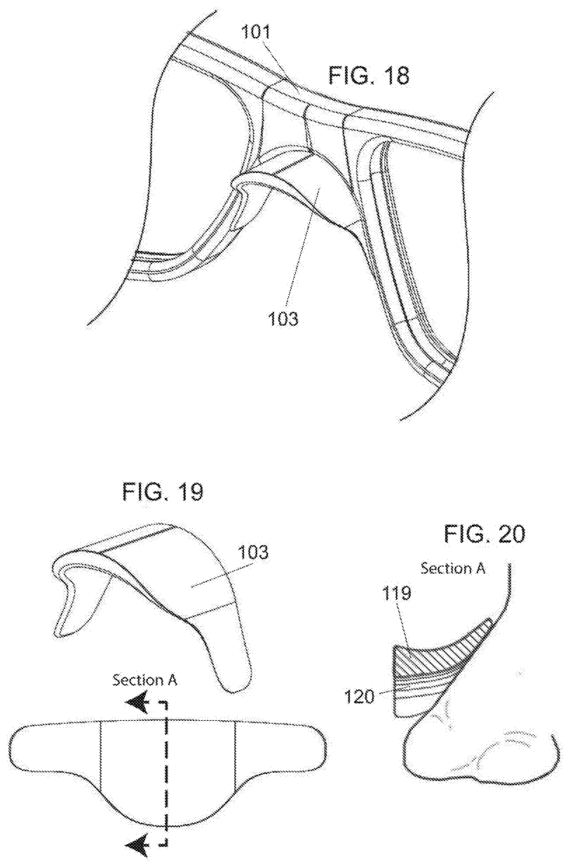

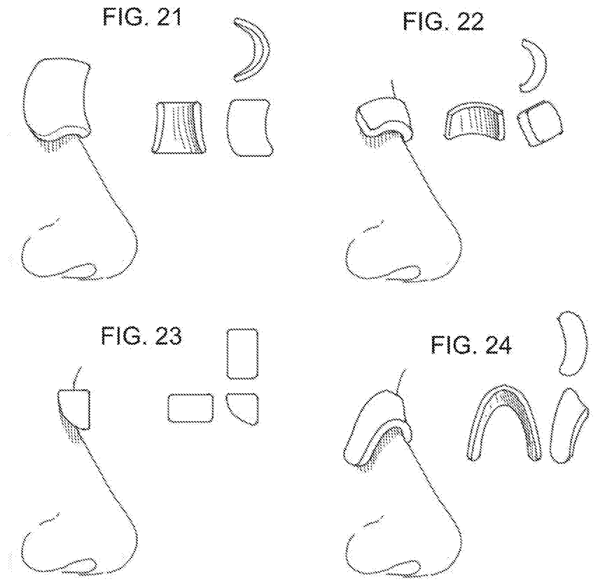

FIGS. 18-20 show an implementation of a nosepiece 103 that may be adhered to an eyewear frame 100 to allow a user to retrofit existing eyewear or that may be made to fit a custom eyewear frame 100 to create a more integrated and seamless look. As shown, the nosepiece 103 may be flat or hemispherically curved to splay outward at the point of contact with the user's nasion and/or nasal bridge. This allows for the lower durometer outer layer 119 of the nosepiece 103 to have increased surface area in contact with the user's nasion and/or nasal bridge to increase the frictional force thereby resisting slippage of the eyewear down the nasal bridge. As shown in the cross-sectional view of FIG. 20, any higher durometer materials used in the inner core 120 of the nosepiece are sufficiently soft and flexible enough to allow the nosepiece 103 to bend and match the contours of the user's nasal bridge and/or nasion. Additionally, FIGS. 21-24 provide non-limiting examples of various shapes and sizes of nosepieces 103 that offer varying amounts of surface area in contact with the user's nasion and/or nasal bridge.

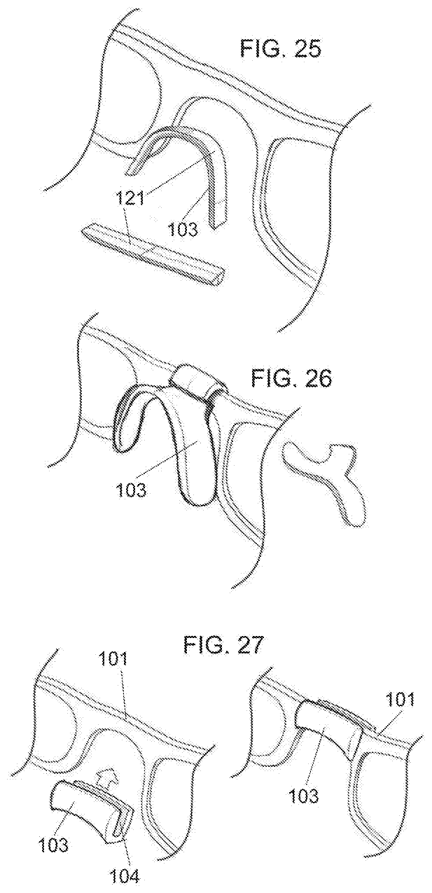

FIGS. 25-27 comprise exemplary implementations of nosepieces 103 designed to retrofit an existing eyewear frame 100. FIG. 25 shows a strip of an adhesive material 121 that may be adhered to the underside of an existing eyewear frame 100 and which also adheres the nosepiece 103 to the eyewear frame 100. FIG. 26 shows an example of a nosepiece 103 comprised of an inner core 120 and outer layer 119 that are sufficiently flexible to allow the nosepiece to be bent or molded to conform to the shape of an existing eyewear frame 100 while holding the shape of the nosepiece 103 and maintaining the nosepiece in place on the eyewear frame once the nosepiece 103 is bent or molded. FIG. 27 depicts a nosepiece 103 comprising a curved or wedge-like shape that is configured to engage the nasion of a user. The nosepiece 103 further comprises a slot 104 or notch configured to receive the bridge 101 of an eyewear frame 100 and hold the nosepiece 103 in place using a friction fit.

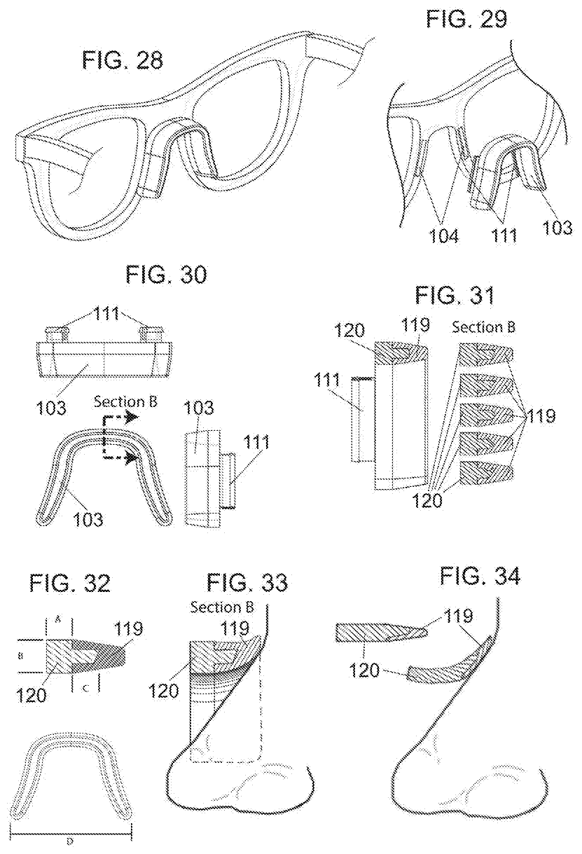

FIGS. 28-34 depict an implementation of an eyewear system comprising an eyewear frame 100 with a plurality of slots 104 configured to accept a snap-in saddle-style nosepiece 103. As shown in FIG. 30, the nosepiece 103 may comprise one or more tabs 111 or other protrusions configured to seat within the slots 104 as shown in FIG. 29. FIG. 32 depicts a cross-sectional view of an exemplary embodiment of the nosepiece 103 which comprises a soft, low durometer material comprising the outer layer 119 of the nosepiece 103 with a firmer, higher durometer material forming the core 120 of the nosepiece 103. FIG. 31 depicts various non-limiting examples of the cross-sectional form of the inner core 120 and outer lower durometer material 119. The shaping of the firmer inner core 120 relative to the lower durometer outer layer 119 may be customized to optimize user comfort and fit. The dimensions A, B, C, and D shown in FIG. 32 may be customized to fit user preferences and may be produced in varying thicknesses and shapes to tune the positioning of the nosepiece on the nasion and/or nose of a user. FIG. 34 depicts a thinner, alternative embodiment of this design.

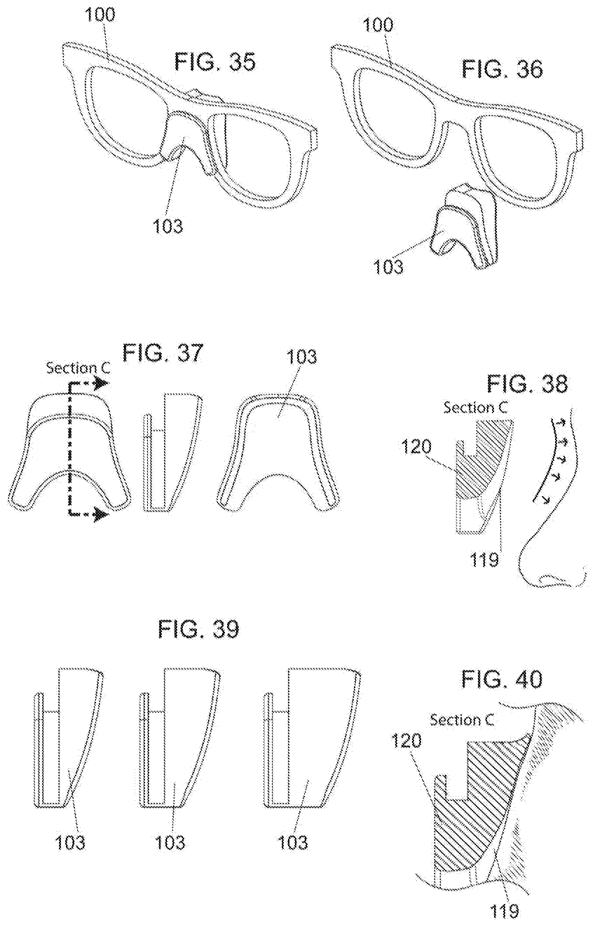

FIGS. 35-40 depict an implementation of an eyewear system comprising an eyewear frame 100 with a nosepiece 103 that is configured to be wedged into place by the user with a friction fit. This ease of coupling and removing the nosepiece 103 to/from the eyewear frame 100 allows the nosepiece 103 to be easily removed for cleaning and then replaced. As shown in FIGS. 38 and 40, the nosepiece 103 may contact the user's nose on the nasal bridge, nasion, and/or glabella, enhancing frictional retention in a vertically and laterally stable anatomical area. FIG. 39 depicts by non-limiting example how the nosepiece may be produced in various sizes and offsets to allow the user to select the best fit.

FIGS. 41-44 depict an embodiment of an eyewear system comprising a nosepiece 103 configured to engage with the nasion of a user. As depicted in the cross-sectional view of FIG. 43, the nosepiece 103 may comprise an inner core 120 comprised of a firmer, higher durometer material as compared to the softer, lower durometer material of the outer layer 119 of the nosepiece 103. The core 120 and/or outer layer 119 may comprise various shapes to influence the flexibility of the outer layer 119. In some embodiments as shown in FIG. 44, the nosepiece 103 may comprise an air gap 122 located between the core 120 and the outer layer 119 which allows the inner core 120 to move and flow freely against the user's nose and/or nasion when the weight of the eyewear frame 100 is resting upon the user's face, thereby providing immediate reciprocal resistance to retard slippage of the eyewear system.

FIGS. 45-48 depict an exemplary implementation of an eyewear system comprising an eyewear frame 100 and a nosepiece 103 configured to engage with the nasion of a user. As shown, the nosepiece 103 may comprise a plurality of flaps 123 which fold against the nose and/or nasion of the user thereby creating a leading and trailing edge of softer, low durometer material 119 which provides a frictional secure fit.

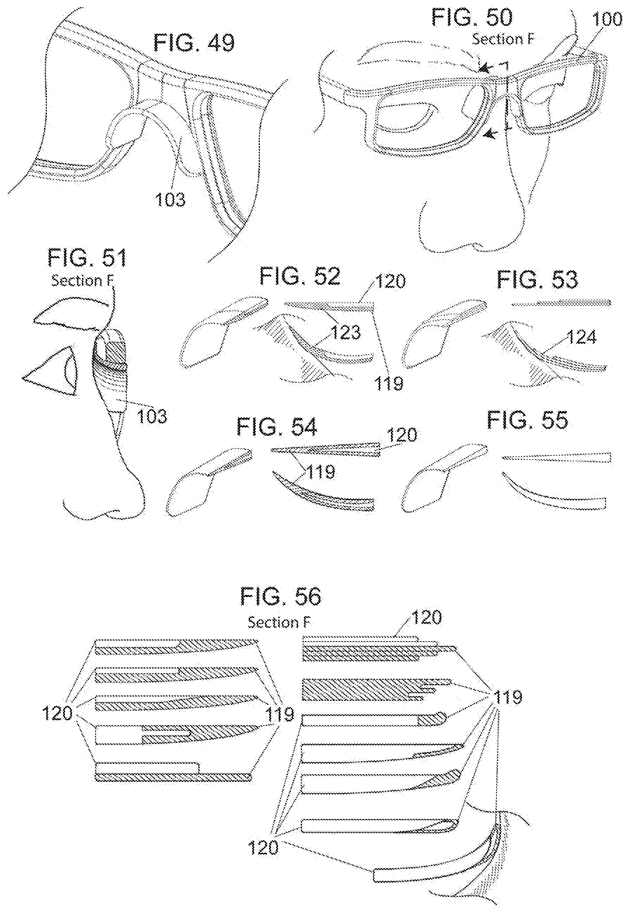

FIGS. 49-56 show an implementation of an eyewear system comprising a nosepiece 103 configured to deform and lay against a user's nasal root, nasion, and/or glabella when in use. FIG. 51 provides a cross-sectional view that bisects the eyewear frame 100 and nosepiece 103 along the centerline. As shown, the flexible flap 123 folds and lays against the user's nose and/or nasion in a vertical position such that the flexible flap 123 grips the skin of the user. FIGS. 52-56 show non-limiting examples of variations of the nosepiece 103. FIG. 52 shows an embodiment of the nosepiece 103 comprising a soft, lower durometer outer layer 119 which is supported by a firmer, higher durometer backing layer 120. FIG. 53 provides a version of the nosepiece 103 that comprises three thin layers comprising a leaf spring 124 that creates a gradual transition from firmer to softer materials across the pad with the softer, lower durometer materials being present closer to the nasal surface of the user. FIGS. 54-55 depict a wedge-like shape of the nosepiece 103 in which the wider end of the nosepiece 103 is comprised of a firmer, higher durometer material 120 and the thinner end of the nosepiece is comprised of a softer, lower durometer material 119. FIG. 56 depicts by non-limiting example, various cross-sectional designs of the portion of the nosepiece 103 that is configured to be proximal a user's nose and/or nasion when in use. The areas depicted in white are intended to represent a firmer, higher durometer backing material 120 as compared to the cross-hatched areas which represent a softer, lower durometer material 119 that is deformable which enhances the grip of this material on the nose and/or nasion of the user. At least some of the various shapes depicted may comprise multiple layers of material of varying durometers.

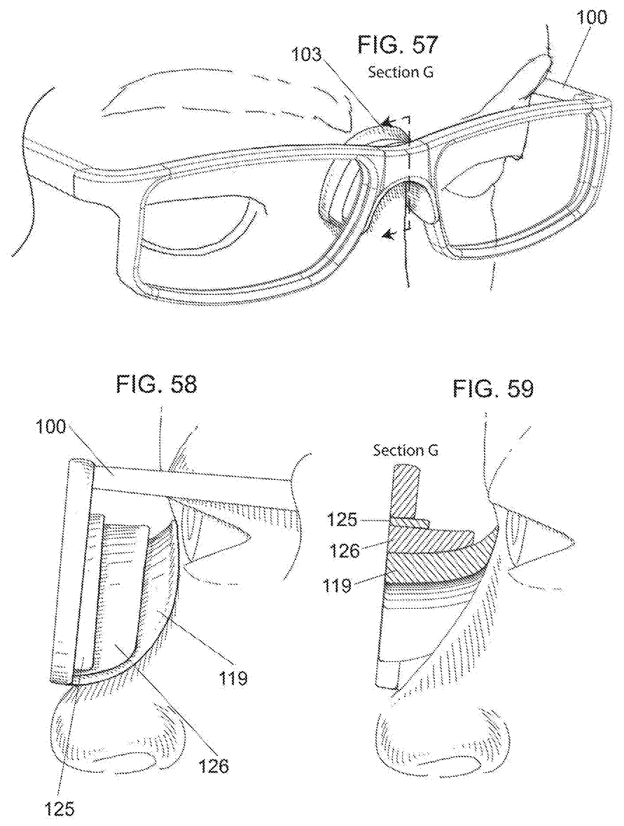

FIGS. 57-59 show an implementation of an eyewear system comprising a hemispherical nosepiece 103. As depicted in the side view of FIG. 58, the nosepiece 103 is comprised of a plurality of layers of various materials. In the example shown, the nosepiece 103 comprises a layer of a material 125 of sufficient rigidity to couple the nosepiece 103 to the eyewear frame 100. A soft, low durometer material that is highly adaptable and ultra flexible comprises the layer 119 of the nosepiece 103 that contacts the user's nose and which allows this layer 119 to deform to increase grip and reduce eyewear slippage. The middle layer 126 is comprised of a material that is of a higher durometer than the soft, low durometer material while still being flexible enough to influence the degree of flex of the soft, low durometer layer. The length and thickness of these various layers may be customized to create a desirable fit for the user. FIG. 59 provides a cross-sectional view that bisects the eyewear frame 100 and depicts an example of how the layers are positioned relative to one another. By varying the thickness of the various layers, the height at which the eyewear frame 100 rests on the face of the user may be adjusted for optimal fit. By varying the shape of the edge of the middle layer 126, the position of the soft, low durometer material 119 varies on the user's nose and may be customized to fit user preferences.

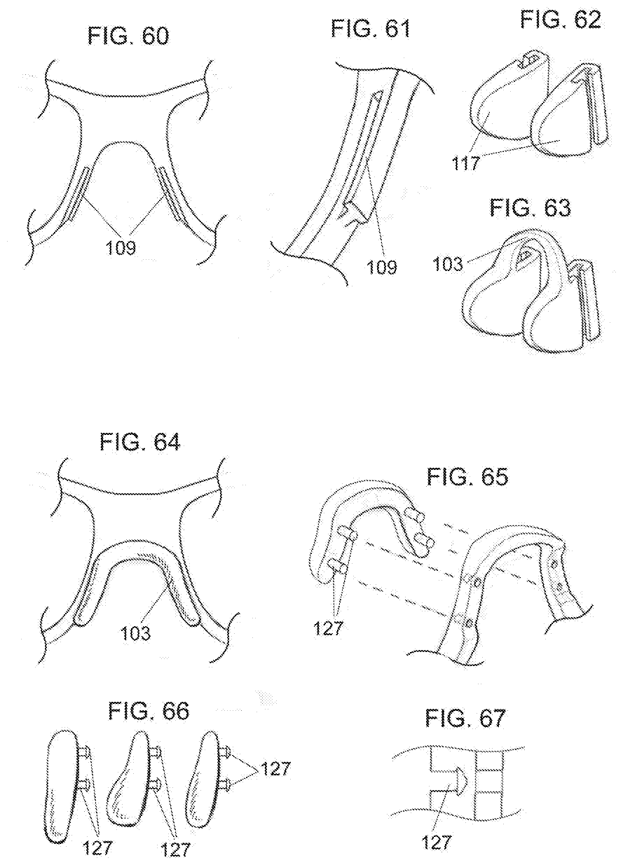

FIGS. 60-67 depict an eyewear system comprising an eyewear frame 100 comprising a rail 109 that is configured to accept a snap-in nosepiece 103 comprising one or more posts or other protrusions.

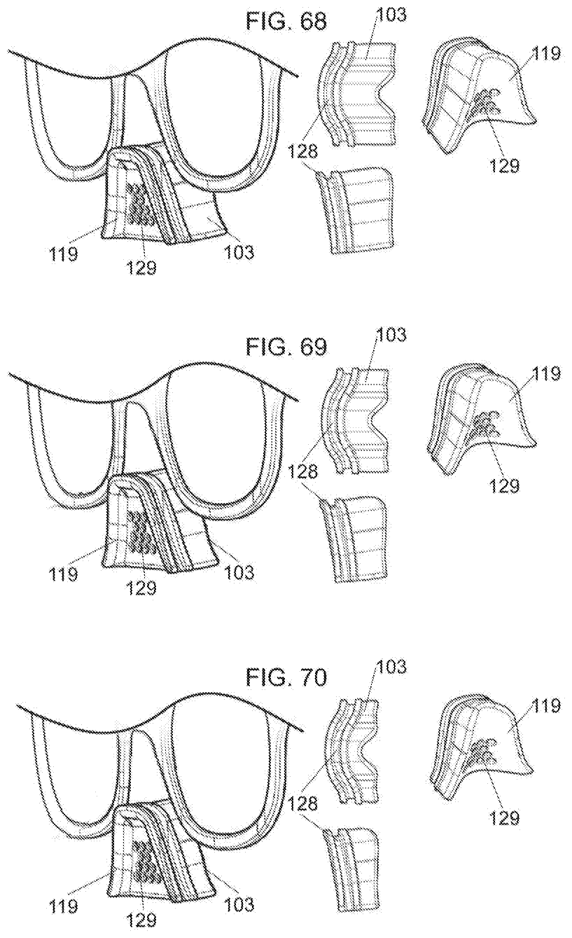

FIGS. 68-70 depict an eyewear system comprising a nosepiece 103 having at least an outer layer 119 comprised of a soft, low durometer material that is configured with a channel 128 or groove that allows the nosepiece 103 to slide onto the frame 100 and remain in place with a friction fit. As shown, the nosepiece 103 may comprise one or more perforations or openings 129 therethrough to increase air flow to enhance the comfort of the user. The fit of the eyewear system on the face of a user may be customized by changing the thickness of the nosepiece 103.

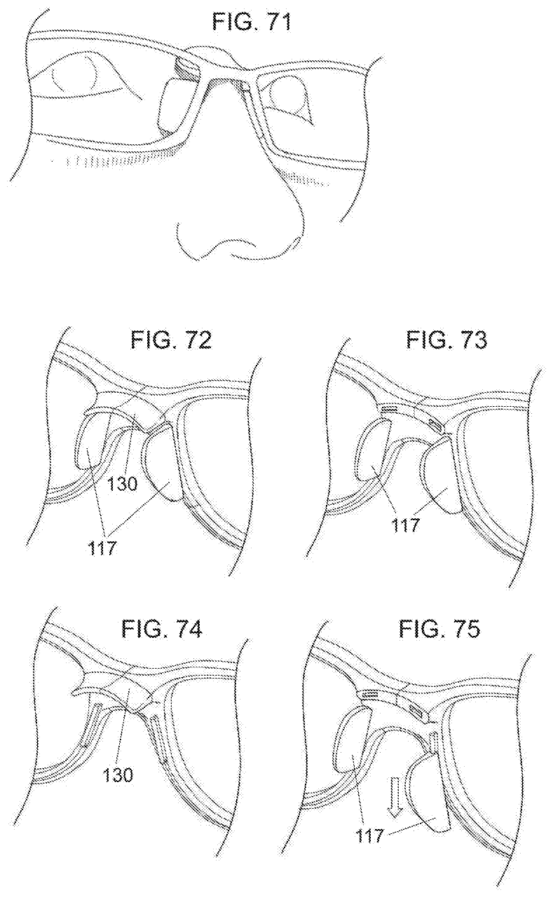

FIGS. 71-75 provide an implementation of an eyewear system comprising a nasion pad 130 and two nose pads 117, any of which are removable and configured to attach independently to the eyewear frame 100 so that the user may chose use all, some, or none of the pads. In some embodiments, the pads 130, 117 may be comprised of a thin, flexible surface that allows for even pressure distribution on the nasal surface and/or additional pressure on the nasion to reduce the load on the nose pads 117.

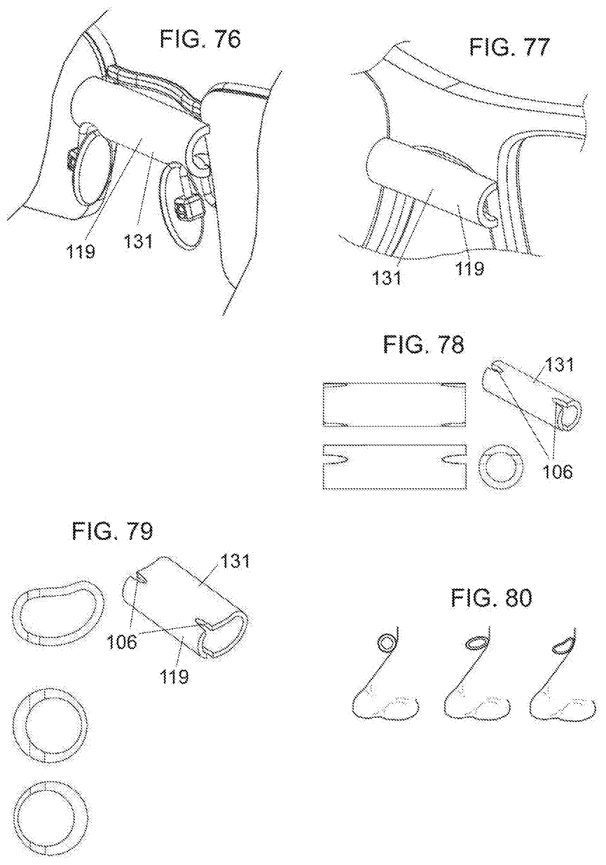

FIGS. 76-80 depict a hollow, flexible tube of low durometer material 119 comprising one or more notches 106 at one or both ends that allow an existing eyewear frame 100 to be retrofitted to create a secure fit for the user. As shown in FIG. 79, the tube may comprise various cross-sectional shapes and thicknesses to create different elastic properties of the tube which influence the fit and allow for user customization.

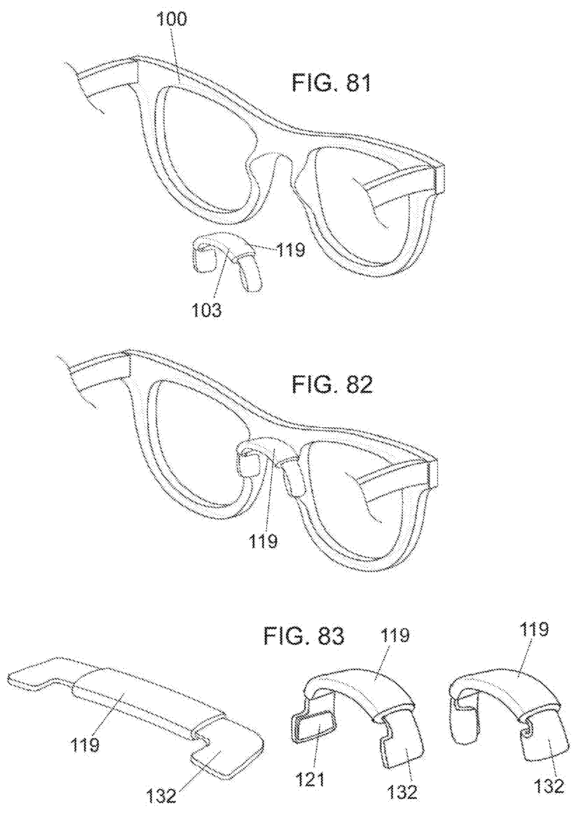

FIGS. 81-83 provide an example of a nosepiece 103 that is configured to couple to the nosepads 117 of an eyewear frame having nose pads that are integral to the frame 100. The nosepiece 103 may couple to the frame 100 using an adhesive strip. As shown in FIG. 83, the nosepiece 103 may comprise a flexible strip 132 with a soft, low durometer material 119 wrapped around the flexible strip 132. As the flexible strip 132 is folded, adhesive pads 121 on the ends of the strip 132 may be folded around the existing nose pads 117 and adhered to the eyewear frame 100.

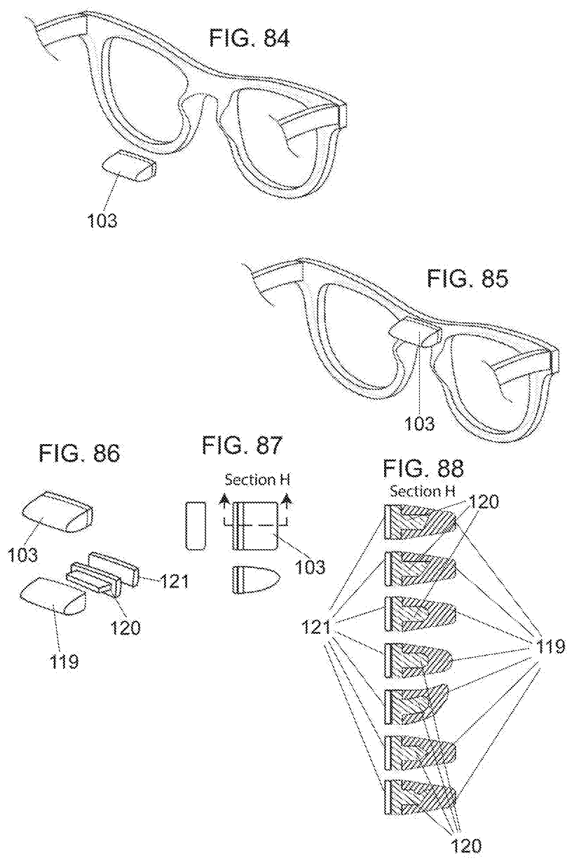

FIGS. 84-88 depict a nosepiece 103 configured to couple to an eyewear frame 100 using an adhesive backing 121. In an exemplary embodiment, the nosepiece 103 is configured to engage with the nasion of a user and comprises a soft, low durometer outer layer 119 and a higher durometer material 120 that retains flexibility such as by non-limiting example, a foam. The shape of the edge of the higher durometer material 120 influences the flexibility and softness of the outer layer 119 to produce a customized fit as shown in FIG. 88.

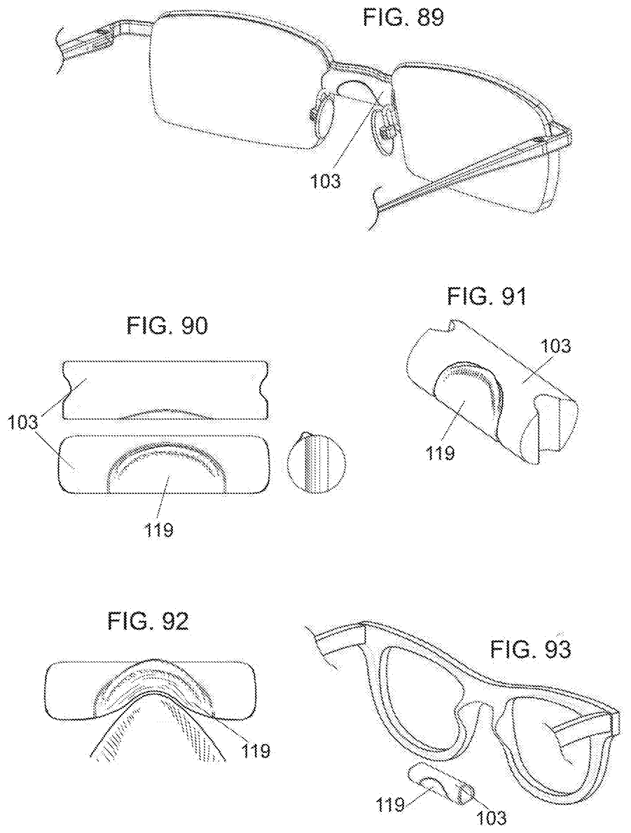

FIGS. 89-93 provide an exemplary implementation of a nosepiece 103 that is retrofitted to an existing eyewear frame 100. The nosepiece 103 comprises a substantially cylindrical shape and is comprised of a soft, flexible material. Some implementations may further comprise a second soft, lower durometer material 119 positioned at about the middle of the nosepiece 103 that is configured to engage with the nose of a user. The soft, lower durometer material 119 enhances friction to increase grip and reduce eyewear slippage. FIG. 93 depicts an implementation comprising a bump, ridge, or asperity in the soft, lower durometer material 119 which may enhance friction.

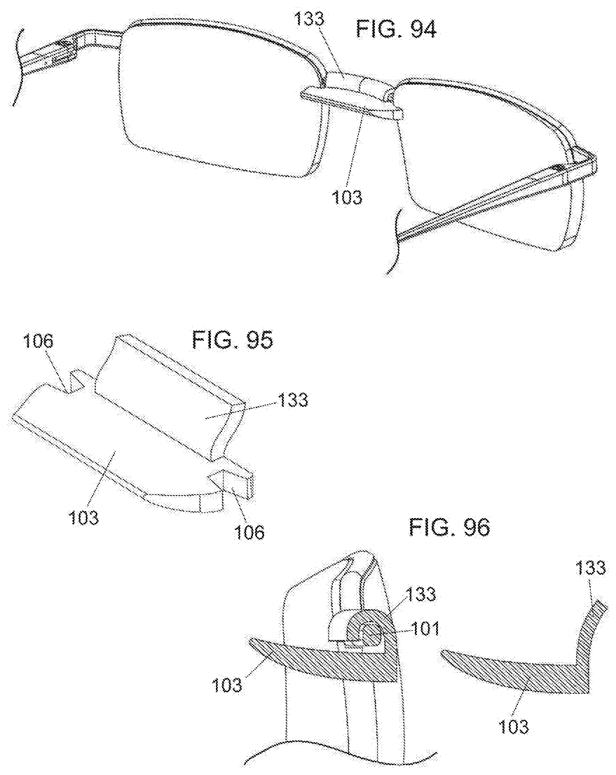

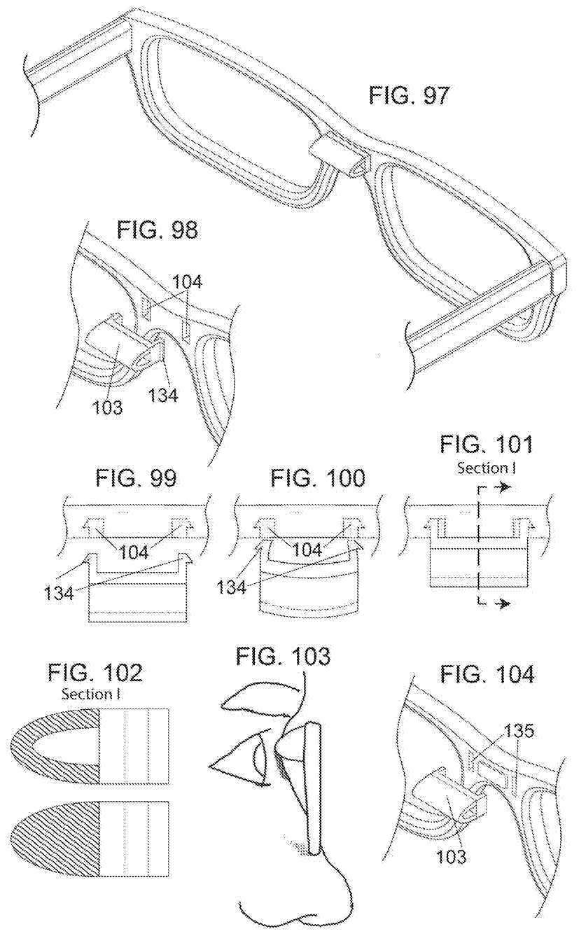

FIGS. 94-96 depict an exemplary embodiment of a nosepiece 103 that is retrofitted to an existing eyewear frame 100. As shown in FIG. 95, the nosepiece 103 may comprise a one or more notches 106 on at least one side and an upper flap 133 that is configured to wrap around the bridge 101 of an eyewear frame 100 to secure the nosepiece 103 to the eyewear frame 100. The notched side aids in securing the nosepiece 103 by holding onto the sides of the eyewear frame 100 which prevents rotation of the nosepiece 103 around the bridge 101 of the eyewear frame 100 when in use.

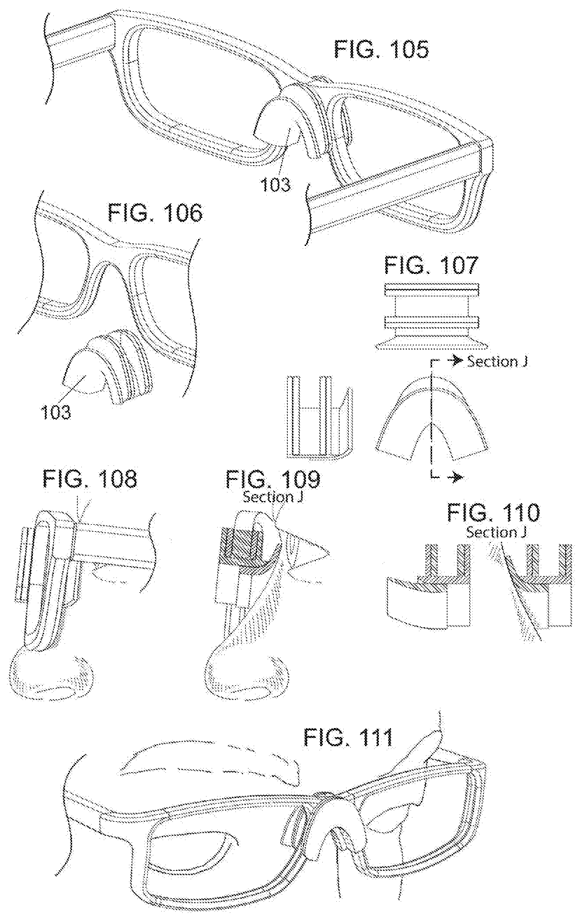

FIGS. 97-104 show an implementation of an eyewear system comprising an eyewear frame 100 having one or more guiding slots 104 or other openings in the bridge 101 of the eyewear frame 100 configured to receive a corresponding protrusion 134 extending from a nosepiece 103 configured to engage the nasion of a user. The nosepiece 103 may be snapped into place and removed by pinching and pushing or pulling on the nosepiece 103. FIG. 104 provides an implementation in which the nosepiece 103 comprises one or more magnetic elements 135 configured to mate with one or more magnetic elements 135 in the one or more guiding slots 104 on the bridge 101 of the eyewear frame 100. As depicted in FIG. 102, the nosepiece 103 may comprise a hollow tube, a solid material, or an air pocket within the nosepiece 103.

FIGS. 105-111 depict an eyewear system comprising a saddle-style nosepiece 103 that is configured to be retrofitted to existing eyewear frames 100. Because eyewear frames 100 vary in size and thickness, the nosepiece 103 comprises a soft, lower durometer material that has sufficient flexibility to be wedged and conformed to fit around the various types of eyewear frames. In FIG. 109, this soft, low durometer material is represented by the strips that are touching either side of the eyewear frame 100.

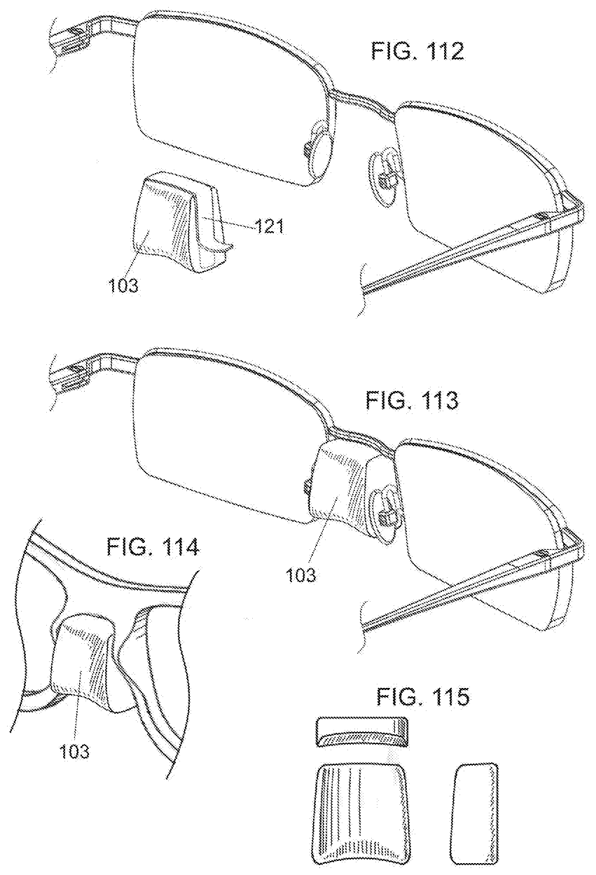

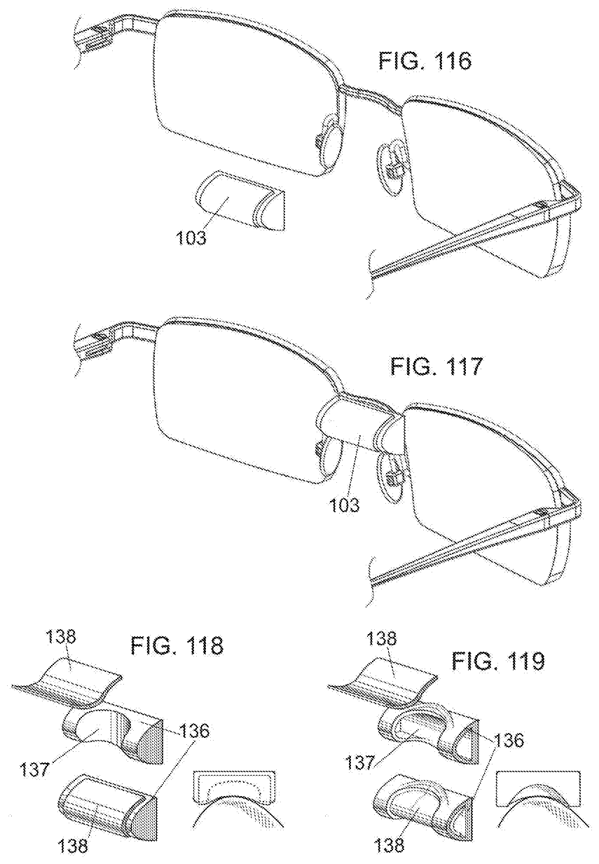

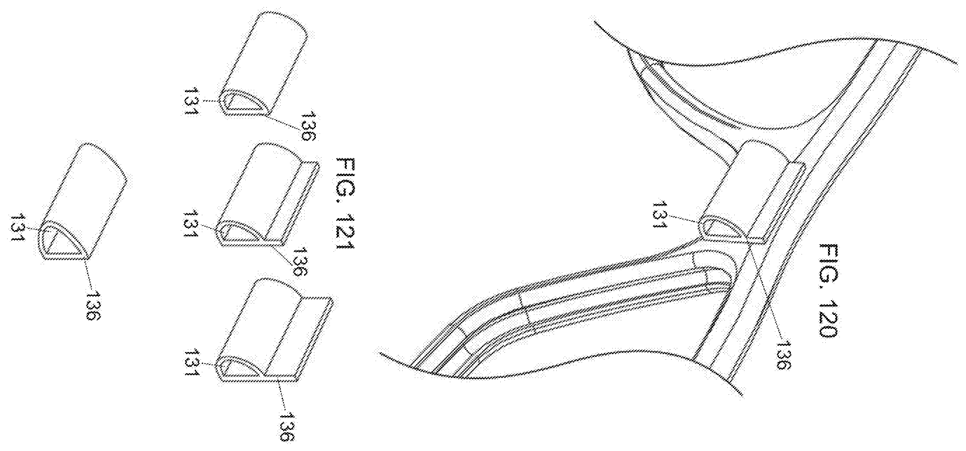

FIGS. 112-115 depict an eyewear system comprising a soft, low durometer wedge-shaped nosepiece 103 comprising a removable adhesive strip 121 configured to adhere the nosepiece 103 to the eyewear frame 100 so as to retrofit existing eyewear with the nosepiece 103.

FIGS. 116-119 provide an eyewear system comprising a nosepiece 103 configured to be wedged in place and adhesively coupled to the bridge 101 of the eyewear frame 100. FIG. 118 depicts an implementation comprising a soft, low durometer backing piece 136 comprising a hollow cutout 137. A sheet of material 138 having sufficient elastic properties is then coupled over the hollow cutout 137 thereby creating a spring-like platform for the nose of the user. As the eyewear frame 100 is loaded onto the nose of the user the protrusions on the backing piece bend inward, thereby softly caressing the nose of the user. FIG. 119 depicts an implementation of the nosepiece comprising a hollow backing material 136. The sheet of sufficiently elastic material 138 is positioned inside this hollow backing material 136 such that as the nose of a user deforms the elastic material, the sheet of elastic material 138 rests against a ridge or other asperity of the backing material 136 and enhances the friction between the nosepiece 103 and the nose of the user.

FIGS. 120-121 depict an implementation of a nosepiece 103 comprised of a hollow tube 131 of soft, low durometer material 119 which may optionally comprise a substantially planar backing structure 136. The nosepiece 103 is configured to adhere to the bridge 101 of an eyewear frame 100 and may comprise various widths and thicknesses as shown in FIG. 121 to provide a custom fit for the user.

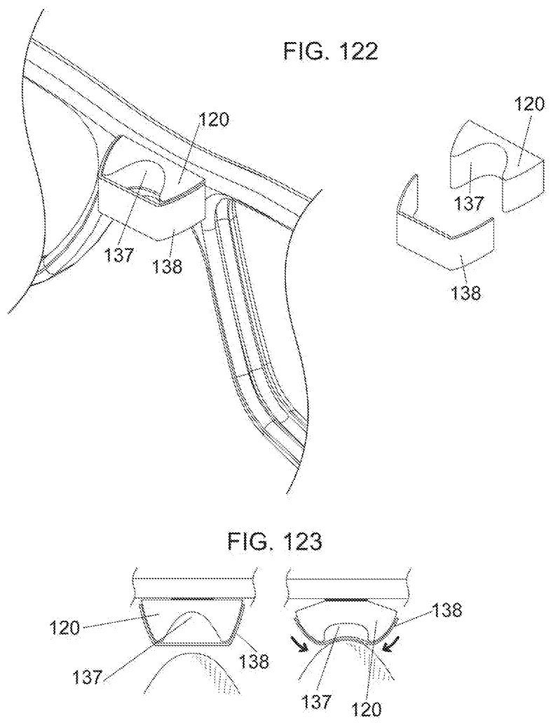

FIGS. 122-123 provide an example of a nosepiece 103 comprised of a higher durometer material 120 such as by non-limiting example, a foam, configured with a cutout 137 or indentation which is covered by a sheet of soft, lower durometer material 138. When the sheet of soft, lower durometer material 138 is in contact with the user's nasal bridge or nasion, the elasticity of the sheet 138 causes the higher, durometer material 120 to deform such that the outer edges bend toward the user's facial surface thereby reducing pressure on the user's face from the eyewear frame 100 and increasing friction to prevent eyewear slippage. The nosepiece 103 may be coupled to the bridge 101 of the eyewear frame 100 using an adhesive, magnet, or other appropriate attachment mechanism.

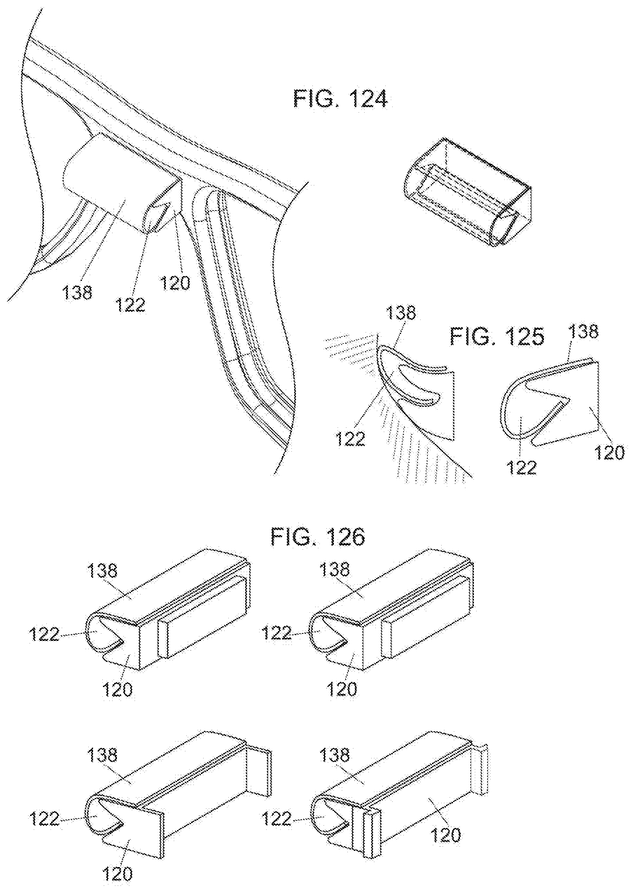

FIGS. 124-126 depict an exemplary embodiment of a nosepiece 103 that may be coupled to the bridge 101 of an eyewear frame 100 using an adhesive, a magnet, one or more friction fit tabs, or one of more snap in and quick release components as shown in FIG. 126. The nosepiece may comprise a higher durometer material 120 and a sheet of a softer, lower durometer material 138 configured to wrap over the higher durometer material 120 such that an air pocket 122 is formed. When the nosepiece 103 is in contact with the nasal bridge or nasion of a user, the soft, lower durometer material 138 deforms thereby increasing friction to prevent slippage of the eyewear. Additionally, provided that the higher durometer material 120 is of sufficient flexibility, such as for example, a foam, the higher durometer material 120 also deforms to increase friction and prevent slippage of the eyewear frame 100 as shown in FIG. 256. The shape of the higher durometer material 120 relative to the placement of the soft, lower durometer material 138 may be varied to provide a customized fit.

It will be understood that implementations are not limited to the specific components disclosed herein, as virtually any components consistent with the intended operation of a method and/or system implementation for eyewear may be utilized. Accordingly, for example, although eyewear systems may be disclosed, such components may comprise any shape, size, style, type, model, version, class, grade, measurement, concentration, material, weight, quantity, and/or the like consistent with the intended operation of a method and/or system implementation for eyewear may be used. In places where the description above refers to particular implementations of eyewear, it should be readily apparent that a number of modifications may be made without departing from the spirit thereof and that these implementations may be applied to other eyewear systems.

We claim:

1. An anti-slip eyewear system comprising:
a nosepiece configured to couple to a bridge of an eyewear frame, the nosepiece comprising:
a core comprised of a first material; and
an outer layer at least partially surrounding the core and comprised of a second material, the second material having a lower durometer than the first material and wherein the second material creates a plurality of Schallamach waves on an outer surface of the nosepiece when the outer layer of the nosepiece is in contact with at least a portion of a face of a user.

2. The anti-slip eyewear system of claim 1, wherein the first material has a durometer greater than about Shore 40A on the Shore A hardness scale.

3. The anti-slip eyewear system of claim 1, wherein the second material has a durometer less than about Shore 40A on the Shore A hardness scale.

4. The anti-slip eyewear system of claim 1, wherein the nosepiece further comprises an attachment tab configured to seat within a slot on a bridge of an eyewear frame.

5. The anti-slip eyewear system of claim 1, wherein the nosepiece further comprises a plurality of attachment arms configured to couple the nosepiece to a bridge of an eyewear frame.

6. The anti-slip eyewear system of claim 1, wherein the nosepiece further comprises an adhesive configured to couple the nosepiece to a bridge of an eyewear frame.

7. The anti-slip eyewear system of claim 1, wherein the nosepiece comprises a saddle shape configured to engage a nasion and a nose of a user.

8. The anti-slip eyewear system of claim 7, wherein the saddle shape is comprised of an upper nosepiece portion and a plurality of nose pads.

9. An anti-slip eyewear system comprising:
a nosepiece configured to couple to a bridge of an eyewear frame, the nosepiece comprising:
a core comprised of a first material; and
an outer layer at least partially overlapping the core and comprised of a second material, the second material having a lower durometer than the first material and wherein the second material creates a plurality of Schallamach waves on an outer surface of the nosepiece when the outer layer of the nosepiece is in contact with at least a portion of a face of a user.

10. The anti-slip eyewear system of claim 9, wherein the first material has a durometer greater than about Shore 40A on the Shore A hardness scale.

11. The anti-slip eyewear system of claim 9, wherein the second material has a durometer less than about Shore 40A on the Shore A hardness scale.

12. The anti-slip eyewear system of claim 9, wherein the nosepiece comprises a saddle shape configured to engage a nasion and a nose of a user.

13. A method for preventing slippage of an eyewear system comprising:
coupling a nosepiece to a bridge of an eyewear frame, the nosepiece comprising:
a core comprised of a first material; and
an outer layer at least partially overlapping the core and comprised of a second material, the second material having a lower durometer than the first material; and
creating a plurality of Schallamach waves in the second material on the outer layer of the nosepiece when the outer layer of the nosepiece is in contact with at least a portion of a face of a user.

14. The method of claim 13, wherein the first material has a durometer greater than about Shore 40A on the Shore A hardness scale.

15. The method of claim 13, wherein the second material has a durometer less than about Shore 40A on the Shore A hardness scale.

16. The method of claim 13, further comprising seating an attachment tab within a slot on a bridge of an eyewear frame.

17. The method of claim 13, further comprising coupling a plurality of attachment arms of the nosepiece to a bridge of an eyewear frame.

18. The method of claim 13, further comprising adhering the nosepiece to a bridge of an eyewear frame using an adhesive.

19. The method of claim 13, wherein the nosepiece comprises a saddle shape configured to engage a nasion and a nose of a user.

20. The method of claim 19, wherein the saddle shape is comprised of an upper nosepiece portion and a plurality of nose pads.
